(19) United States
(12) Patent Application Publication
(10) Pub. No.: US 2023/0135536 A1
(43) Pub. Date: May 4, 2023

(54) Method and Apparatus for Processing Table

(71) Applicant: Beijing Baidu Netcom Science Technology Co., Ltd., Beijing (CN)

(72) Inventors: Chenhui LI, Beijing (CN); Teng HU, Beijing (CN); Shikun FENG, Beijing (CN); Yongfeng CHEN, Beijing (CN)

(21) Appl. No.: 18/089,395

(22) Filed: Dec. 27, 2022

(30) Foreign Application Priority Data
May 27, 2022 (CN) 202210591760.9

(51) Int. Cl. G06F 16/33; G06F 16/31

(52) U.S. Cl. CPC G06F 16/3331; G06F 16/316

(57) ABSTRACT

A method and an apparatus for processing a table are provided. The method includes: obtaining text information of cells in the table; obtaining structure information of the cells in the table; and inputting a query word, the text information, and the structure information of the table into a table information extraction model to obtain an answer output from the table information extraction model, wherein the output answer corresponds to the query word in the table.

### CROSS-REFERENCE TO RELATED APPLICATIONS

The present application claims the priority of Chinese Patent Application No. 202210591760.9, titled “METHOD AND APPARATUS FOR PROCESSING TABLE”, filed on May 27, 2022, which is incorporated herein by reference in its entirety.

### TECHNICAL FIELD

The present disclosure relates to the field of computer technologies, in particular to the field of natural language processing and deep learning technologies, and more particularly to a method and apparatus for processing a table.

### BACKGROUND

A table is used for data storage and distribution, and it is clear in format, convenient to store, and easy to spread. In real world, a large amount of information exists in a variety of tables, but it is difficult to correctly understand what information is stored in the tables. In related technologies, extraction of table information is relatively dependent on manual interpretation.

Automatic table information extraction is an effective means to save manpower and improve efficiency. At the same time, content of a database table containing text is richer, which brings a greater challenge for extracting information from the table containing text.

### SUMMARY

A method and an apparatus for processing a table, an electronic device, and a storage medium are provided.

Some embodiments of the present disclosure provide a method for processing a table, including: obtaining text information of cells in the table; obtaining structure information of the cells in the table; and inputting a query word, the text information, and the structure information of the table into a table information extraction model to obtain an answer output from the table information extraction model, wherein the output answer corresponds to the query word in the table.

Some embodiments of the present disclosure provide a method for training a table information extraction model, wherein the trained table information extraction model is a model in the first aspect, including: obtaining text information and structure information of cells in a target table, and inputting the text information, the structure information and a query word of labeling information to a to-be-trained table information extraction model to obtain an output answer, wherein a truth value corresponding to the output answer in the labeling information is text content of a cell corresponding to a header of the target table; training the to-be-trained table information extraction model by using the output answer and the truth value corresponding to the output answer to obtain a pre-trained table information extraction model; and training the pre-trained table information extraction model by using training samples to obtain the trained table information extraction model.

Some embodiments of the present disclosure provide an apparatus for processing a table, including: a text obtaining unit configured to obtain text information of cells in the table; a structure obtaining unit configured to obtain structure information of the cells in the table; and an inputting unit configured to input a query word, the text information, and the structure information of the table into a table information extraction model to obtain an answer output from the table information extraction model, wherein the output answer corresponds to the query word in the table.

Some embodiments of the present disclosure provide an apparatus for training a table information extraction model, wherein the trained table information extraction model is a model in the third aspect, and the apparatus includes: an inputting unit configured to obtain text information and structure information of cells in a target table, and input the text information, the structure information and a query word of labeling information to a to-be-trained table information extraction model to obtain an output answer, wherein a truth value corresponding to the output answer in the labeling information is text content of a cell corresponding to a header of the target table; a pre-training unit configured to train the to-be-trained table information extraction model by using the output answer and the truth value corresponding to the output answer to obtain a pre-trained table information extraction model; and a post-training unit configured to train the pre-trained table information extraction model by using training samples to obtain the trained table information extraction model.

Some embodiments of the present disclosure provide an electronic device including one or more processors; and a storage device in communication with one or more processor, wherein the storage device stores instructions executable by the one or more processor, to enable the one or more processor to perform the above method.

Some embodiments of the present disclosure provide non-transitory computer readable storage medium, storing a computer instruction, wherein the computer instruction when executed by a computer causes the computer to perform the above method.

Some embodiments of the present disclosure provide a computer program product including a computer program, wherein the computer program, when executed by a processor, causes the processor to perform the above method.

### BRIEF DESCRIPTION OF THE DRAWINGS

Other features, objectives and advantages of the present disclosure will become more apparent upon reading the detailed description of non-limiting embodiment with reference to the following accompanying drawings.

FIG. 1 is an exemplary system architecture in which some embodiments of the present disclosure may be applied;

FIG. 2 is a flowchart of a method for processing a table according to an embodiment of the present disclosure;

FIG. 3 is a schematic diagram of a table used in a method for processing a table according to the present disclosure;

FIG. 4 is a flowchart of a method for training a table information extraction model according to an embodiment of the present disclosure;

FIG. 5 is a schematic structural diagram of an apparatus for processing a table according to one embodiment of the present disclosure; and

FIG. 6 is a block diagram of an electronic device used to implement a method for processing a table according to an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description.

In the technical solution of the present disclosure, the collection, storage, use, processing, transmission, provision, disclosure, etc. of the personal information of a user all comply with the provisions of the relevant laws and regulations, and do not violate public order and good customs.

It should be noted that the embodiments of the present disclosure and features of the embodiments may be combined with each other on a non-conflict basis. The present disclosure will be described below in detail with reference to the accompanying drawings and in combination with the embodiments.

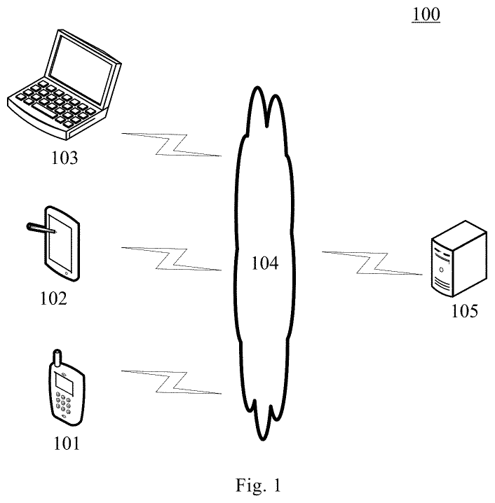

FIG. 1 illustrates an exemplary system architecture 100 in which a method or an apparatus for processing a table may be applied according to embodiments of the present disclosure.

As shown in FIG. 1, the system architecture 100 may include terminal devices 101, 102, and 103, a network 104, and a server 105. The network 104 serves as a medium providing a communication link between the terminal devices 101, 102, 103, and the server 105. The network 104 may include various types of connections, such as wired or wireless communication links, or optical cables.

The user may interact with the server 105 through the network 104 using the terminal devices 101, 102, 103 to receive or send messages, etc. The terminal devices 101, 102, 103 may have various communication client applications installed thereon, such as a video application, a live application, an instant messaging tool, a mailbox client, social platform software, and the like.

A user may use the terminal devices 101, 102, 103 to interact with the server 105 via the network 104 to receive or send messages, or the like. Various communication client applications may be installed on the terminal devices 101, 102, 103, such as video applications, live applications, instant messaging tools, mailbox clients, or social platform software.

The server 105 may be a server providing various services, such as a backend server providing support to the terminal devices 101, 102, 103. The backend server may analyze received data such as a table containing text information and a query word, and feedback a processing result (e.g., an answer to the query word) to the terminal device.

It should be noted that a method for processing a table provided in the embodiment of the present disclosure may be executed by the server 105 or the terminal devices 101, 102, and 103, and accordingly, an apparatus for processing a table may be provided in the server 105 or the terminal devices 101, 102, 103.

It should be understood that the number of the terminal devices, the networks and the servers in FIG. 1 is merely illustrative. There may be any number of the terminal devices, the networks and the servers as desired for implementation.

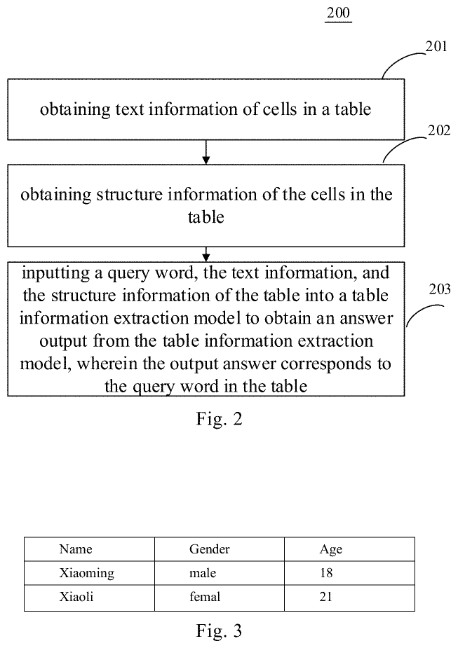

Further referring to FIG. 2, FIG. 2 illustrates a flowchart 200 of a method for processing a table according to an embodiment of the present disclosure. The method for processing the table includes the following steps.

Step 201: obtaining text information of cells in a table.

In the present embodiment, an execution body (such as a server or a terminal device shown in FIG. 1) on which a method for processing a table runs may obtain text information of the cells in the table from the present device or other electronic devices. The table contains texts, and thus, the table generally refers to a document table. The number of the cells is not limited herein, and may be, for example, all cells, or a specified number of cells.

In practice, the text information may refer to vectors obtained by vectorizing the texts. Alternatively, the text information may refer to non-vectors that has not been vectorized.

A vectorization process in the present disclosure may be a word embedding process. For example, a word embedding result is obtained through an identifier of a word, and the word embedding result is a vector.

Step 202: obtaining structure information of the cells in the table.

In the present embodiment, the above-mentioned execution body may obtain the structure information of the cells in the table. The structure information refers to information representing a structure of a table. For example, the structure information may include a row position, a column position of a cell. For example, the row position and the column position may be 2 and 5, indicating that the cell is in the second row and the fifth column.

In practice, the structure information herein may refer to vectors obtained by vectorizing the table structures such as positions. Alternatively, the structure information may refer to a non-vector that has not been vectorized.

The number of cells is not limited herein, and may be, for example, all cells, or a specified number of cells.

Step 203: inputting a query word, the text information, and the structure information of the table into a table information extraction model to obtain an answer output from the table information extraction model, wherein the output answer corresponds to the query word in the table.

In the present embodiment, the above-described execution body may input a to-be-predicted query word of the table, the text information and the structure information of the cells (such as each cell) into the table information extraction model to obtain the answer output from the model. In the table, the output answer is a value of the query word.

The table information extraction model refers to a deep neural network with a language processing capability. For example, the deep neural network may be BERT (Bidirectional Encoder Representations from Transformer), or ERNIE (Enhanced Language Representation with Informative Entities).

The input query word, text information, and structure information may be vectors that have been vectorized. Alternatively, the input may be non-vectors that have not been vectorized. In this case, the table information extraction model has a vectorization capability, and the word embedding processing may be performed on the input.

The method provided in the above embodiments of the present disclosure may utilize a table information extraction model to achieve end-to-end extraction of information in a table. In addition, by extracting the text information and the structure information in the table, the information in the table can be more thoroughly obtained, thereby facilitating to obtain more accurate answers.

In some alternative implementations of any embodiment of the present disclosure, the text information includes the text information of the cell and text information of cells on the left and on the right of the cell in the table. The obtaining the text information of the cell in the table includes: splicing text content of cells in the table according to a preset splicing order to obtain a text sequence, where the splicing order comprises an order from left to right; and determining the text information according to the text sequence.

In the implementations, the text information may reflect a positional relationship of the text contents of the cells, that is, region text information in the table may be reflected. The text contents used as splicing objects may be the texts themselves in the cells. In this case, a splicing object may be a word segmenting result obtained by performing word segmentation on the entire text in the cell, or the entire text itself. In some cases, the text content may also be a vector obtained after the text has been vectorized, and in these cases, the text before vectorization may also be a word segmenting result or the entire text itself.

The above-mentioned execution body may determine the text information according to the text sequence in various ways. For example, the above-mentioned execution body may directly determine the text sequence as the text information. Alternatively, the above-described execution body may vectorize the text sequence and use a vectorized result as the text information.

In the present disclosure, if a row of cells in the table are spliced in an order from left to right, then in a top-to-bottom order, text contents of the next row in are spliced from left to right.

These implementations may reflect context information of the texts in the table by splicing, so that correlations between different texts in the cells may be obtained, and a more thorough information may be input to a model, facilitating to improve an accuracy of the model.

Optionally, the splicing the text contents of the cells in the table according to the preset splicing order to obtain the text sequence includes: placing the query word at a start splicing position, and splicing the text contents of the cells in the table according to the preset splicing sequence from a subsequent splicing position to obtain the text sequence.

Specifically, the above-mentioned execution body may place the query word at the beginning of the text sequence and splice the text contents of the cells in the table from a subsequent position in the order from left to right.

These alternative implementations may arrange the query word at the beginning, being advantageous for the model to analyze the query word.

In some alternative implementations of any embodiment of the present disclosure, the structure information is a vector; where the obtaining the structure information of the cell in the table includes: summing a row position, a column position a merging state and a cell token ID of the cell in the table to obtain summing information; and determining the structure information based on the summing information.

Specifically, a merging state refers to whether or not the cell is a merged cell. For example, if the cell is a merged cell, the merging state may be a vectorized result of a value 1. If the cell is not a merged cell, the merging state may be a vectorized result of a value 0. The cell token ID is a ranking of the cell in the table. For example, the cell token IDs of name, gender, and age in the above table are 1, 2, and 3, respectively. The same merged cell has only one cell token ID.

The above-mentioned execution body may determine the structure information according to the summing information in various ways. For example, the execution body may directly determine the summing information as the structure information. Alternatively, the execution body may perform a preset processing on the summing information, such as multiplying the summing information by a preset coefficient, or inputting the summing information to a preset formula or model. The above-mentioned execution body may take a result obtained after the preset processing as the structure information.

These implementations may extract thorough structure information by fusing the row-column information, the merging information, and the sorting information of the cell.

Further referring to FIG. 3, FIG. 3 illustrates a schematic diagram of a table used in a method for processing a table according to the present disclosure. If the query word is “gender”, a splicing order in which the text contents in the table are spliced may be: gender, name, gender, age, Xiaoming, male, 18, XiaoLi, female, 21. Accordingly, an answer to the query word is “male” or “female”.

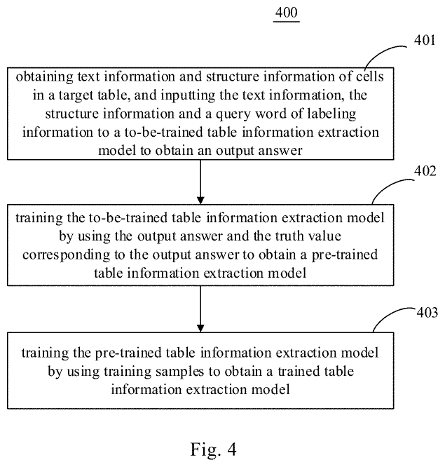

Further referring to FIG. 4, FIG. 4 illustrates a flowchart 400 of a method for training a table information extraction model according to one embodiment of the present disclosure. The trained table information extraction model is the table information extraction model provided in any of the above embodiments. The flowchart 400 includes the following steps.

Step 401: obtaining text information and structure information of cells in a target table, and inputting the text information, the structure information and a query word of labeling information to a to-be-trained table information extraction model to obtain an output answer, where a truth value corresponding to the output answer in the labeling information is text content of a cell corresponding to a header of the target table.

In the present embodiment, any execution body (such as the server or terminal device shown in FIG. 1) on which the method for training a table information extraction model runs may obtain text information and structure information of the cells in a target table (such as each cell). Thereafter, the above-mentioned execution body may input the text information, the structure information, and the query word obtained from the target table to the table information extraction model. Thus, the above-mentioned execution body can obtain a prediction result output from the model, that is, an output answer.

Any electronic device may use a header of the target table as the query word in a new training sample, and use the text content in the cell corresponding to the header as a truth value corresponding to the output answer in the labeling information, thereby obtaining the labeling information of the target table.

Step 402: training the to-be-trained table information extraction model by using the output answer and the truth value corresponding to the output answer to obtain a pre-trained table information extraction model.

In the present embodiment, the execution body may obtain a loss value by using the output answer, the truth value corresponding to the output answer, and a preset loss function. The loss value is used to train the table information extraction model to obtain the pre-trained table information extraction model.

Step 403: training the pre-trained table information extraction model by using training samples to obtain a trained table information extraction model.

In the present embodiment, the above-mentioned execution body may further train the pre-trained table information extraction model by using the training samples, thereby obtaining the trained table information extraction model.

In practice, the above-described execution body may also perform sample expansion in other ways. For example, the electronic device may use other headers in the table as query words in the new training samples, or the electronic device may replace a query word in a training sample with a corresponding synonym.

These alternative implementations may expand the training samples through the headers and use the expanded training samples to train the pre-trained table information extraction model, thereby solving a problem of a low model accuracy caused by insufficient number of training samples and facilitating to improve the model accuracy.

In some alternative application scenarios of the implementations, the text information includes the text information of a cell and text information of cells on the left and on the right of the cell in the table, where the obtaining the text information of the cell in the table includes: splicing text contents of the cells in the table according to a preset splicing order to obtain a text sequence, where the splicing order comprises an order from left to right; and determining the text information according to the text sequence. These application scenarios may illustrate context information of the text in the table by splicing, so that a more thorough information may be input to a model.

Optionally, the method further includes determining a truth label for the output answer corresponding to the query word in the text sequence, where the truth label indicates that the labeled answer is a truth value corresponding to the output answer; and assigning a label different from the truth label to other contents in the text sequence.

These alternative application scenarios may label the text sequence and the output answer to the query word with a truth value label, thereby enabling an efficient extension of the training sample.

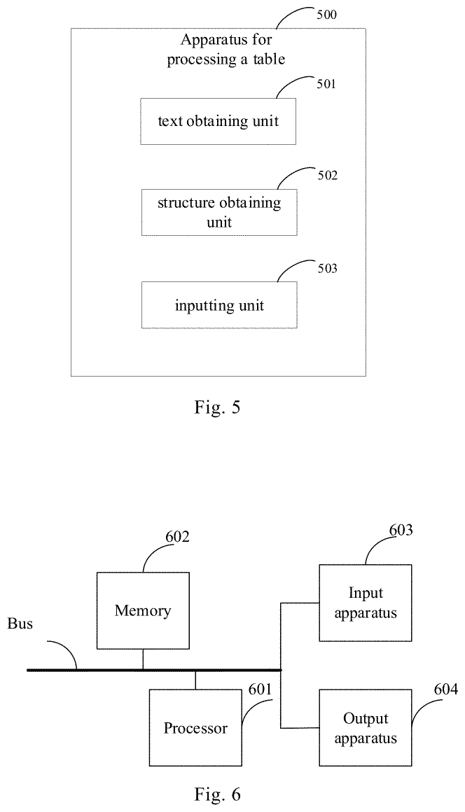

Further referring to FIG. 5, as an implementation of the method shown in each of the above figures, an embodiment of the present disclosure provides an apparatus for processing a table corresponding to the method embodiment shown in FIG. 2, which may include the same or corresponding features or effects as the method embodiment shown in FIG. 2 in addition to the features described below. The device is particularly applicable to various electronic devices.

As shown in FIG. 5, an apparatus 500 for processing a table in the present embodiment includes a text obtaining unit 501, a structure obtaining unit 502, and an inputting unit 503. The text obtaining unit 501 is configured to obtain text information of cells in the table; the structure obtaining unit 502 configured to obtain structure information of the cells in the table; the inputting unit 503 is configured to input a query word, the text information, and the structure information of the table into a table information extraction model to obtain an answer output from the table information extraction model, wherein the output answer corresponds to the query word in the table.

In the present embodiment, the specific processing of the text obtaining unit 501, the structure obtaining unit 502, and the inputting unit 503 of the apparatus 500 for processing a table and the technical effects thereof may be described with reference to the related descriptions of step 201, step 202, and step 203 in the corresponding embodiment of FIG. 2, respectively, and details are not described herein again.

In some alternative implementations of the present embodiment, the text information comprises the text information of the cells and text information of cells on the left and right of the cells in the table; the text obtaining unit is further configured to execute obtaining of the text information of the cells in the table by: splicing text contents of the cells in the table according to a preset splicing order to obtain a text sequence, wherein the splicing order comprises an order from left to right; and determining the text information according to the text sequence.

In some alternative implementations of the present embodiment, the text obtaining unit is further configured to execute splicing of the text contents of the cells in the table according to the preset splicing order to obtain the text sequence by: using a position of the query word as a beginning position, and splicing the text contents of the cells in the table according to the preset splicing sequence from a subsequent position to obtain the text sequence.

In some alternative implementations of the present embodiment, the structure information is a vector; the structure obtaining unit is further configured to execute obtaining of the structure information of the cells in the table by: summing a row position, a column position a merging state and a cell token ID of each of the cells in the table to obtain summing information; and determining the structure information based on the summing information.

The present disclosure also discloses an apparatus for training a table information extraction model, where the trained table information extraction model is a model in the embodiment of FIG. 5, and the apparatus includes: an inputting unit configured to obtain text information and structure information of cells in a target table, and input the text information, the structure information and a query word of labeling information to a to-be-trained table information extraction model to obtain an output answer, wherein a truth value corresponding to the output answer in the labeling information is text content of a cell corresponding to a header of the target table; a pre-training unit configured to train the to-be-trained table information extraction model by using the output answer and the truth value corresponding to the output answer to obtain a pre-trained table information extraction model; and a post-training unit configured to train the pre-trained table information extraction model by using training samples to obtain the trained table information extraction model.

According to an embodiment of the present disclosure, the present disclosure also provides an electronic device, a readable storage medium, and a computer program product.

FIG. 6 is a block diagram of an electronic device used to implement a method for processing a table according to an embodiment of the present disclosure. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 6, the electronic device includes one or more processors 601, a memory 602, and an interface for connecting components, including a high speed interface and a low speed interface. The various components are interconnected by different buses and may be mounted on a common motherboard or otherwise as desired. The processor may process instructions executed within the electronic device, including instructions stored in or on a memory to display graphical information of the GUI on an external input/output device, such as a display device coupled to an interface. In other embodiments, multiple processors and/or multiple buses may be used with multiple memories and multiple memories, if desired. Similarly, a plurality of electronic devices may be connected, each providing a portion of the necessary operations (e.g., as a server array, a set of blade servers, or a multiprocessor system). A processor 601 is exemplified in FIG. 6.

Memory 602 is a non-transitory computer readable storage medium provided by the present disclosure. Wherein the memory stores instructions executable by one or more processor to cause the one or more processor to perform the method for processing a table provided in the present disclosure. The non-transient computer readable storage medium of the present disclosure stores a computer instruction, wherein the computer instruction when executed by a computer causes the computer to perform a method for processing a table provided by the present disclosure.

The memory 602, as a non-transitory computer readable storage medium, can be used to store non-transitory software programs, non-transitory computer executable programs, and modules, such as program instructions/modules (e.g., the text obtaining unit 501, the structure obtaining unit 502, and the input unit 503 shown in FIG. 5) corresponding to a method for processing a table in an embodiment of the present disclosure. The processor 601 executes various functional applications and data processing of the server by running non-transitory software programs, instructions and modules stored in the memory 602, that is, implements the method for processing the table in the above-described method embodiment.

The memory 602 may include a storage program area and a storage data area, wherein the storage program area may store an operating system, an application program required for at least one function; The storage data area may store data or the like created according to the use of the processing electronics of the table. In addition, memory 602 may include high speed random access memory, and may also include non-instantaneous memory, such as at least one magnetic disk storage device, flash memory device, or other non-instantaneous solid state storage device. In some embodiments, memory 602 may optionally include remotely disposed memory relative to processor 601, which may be connected via a network to the processing electronics of the table. Examples of such networks include, but are not limited to, the Internet, enterprise intranets, local area networks, mobile communication networks, and combinations thereof

The electronic device performing the method for processing the table may further include input apparatus 603 and output apparatus 604. The processor 601, the memory 602, the input apparatus 603 and the output apparatus 604 may be connected via a bus or otherwise, as illustrated in FIG. 6.

The input apparatus 603 may receive input number or character information, and generate key signal input related to user settings and functional control of the processing electronic device of the table, such as a touch screen, a keypad, a mouse, a track pad, a touch pad, a pointer bar, one or more mouse buttons, a trackball, a joystick, and the like. The output apparatus 604 may include a display device, an auxiliary lighting device (e.g., an LED), a tactile feedback device (e.g., a vibration motor), and the like. The display device may include, but is not limited to, a liquid crystal display (LCD), a light emitting diode (LED) display, and a plasma display. In some embodiments, the display device may be a touch screen.

The various embodiments of the systems and techniques described herein may be implemented in digital electronic circuit systems, integrated circuit systems, application specific ASICs (application specific integrated circuits), computer hardware, firmware, software, and/or combinations thereof. These various embodiments may include being implemented in one or more computer programs that may execute and/or interpret on a programmable system including at least one programmable processor, which may be a dedicated or general purpose programmable processor, may receive data and instructions from a memory system, at least one input device, and at least one output device, and transmit the data and instructions to the memory system, the at least one input device, and the at least one output device.

These computing programs (also referred to as programs, software, software applications, or code) include machine instructions of a programmable processor and may be implemented in high-level procedures and/or object-oriented programming languages, and/or assembly/machine languages. As used herein, the terms “machine-readable medium” and “computer-readable medium” refer to any computer program product, device, and/or device (e.g., magnetic disk, optical disk, memory, programmable logic device (PLD)) for providing machine instructions and/or data to a programmable processor, including a machine-readable medium that receives machine instructions as machine-readable signals. The term “machine readable signal” refers to any signal used to provide machine instructions and/or data to a programmable processor.

To provide interaction with a user, the systems and techniques described herein may be implemented on a computer having a display device (e.g., a CRT (cathode ray tube) or LCD (liquid crystal display) monitor) for displaying information to the user; And a keyboard and a pointing device (e.g., a mouse or a trackball) through which a user can provide input to a computer. Other types of devices may also be used to provide interaction with a user. For example, the feedback provided to the user may be any form of sensory feedback (e.g., visual feedback, auditory feedback, or tactile feedback); And input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

The computer system may include a client and a server. The client and server are typically remote from each other and typically interact through a communication network. The relationship between the client and the server is generated by a computer program running on the corresponding computer and having a client-server relationship with each other. The server may be a cloud server, also referred to as a cloud computing server or a cloud host, and is a host product in a cloud computing service system, so as to solve a problem that the conventional physical host and the VPS service (Virtual Private Server, VPS for short) are difficult to manage and have weak service scalability. The server may also be a server of a distributed system or a server incorporating a chain of blocks.

Flowcharts and block diagrams in the drawings illustrate architectures, functions, and operations of possible implementations of systems, methods, and computer program products in accordance with various embodiments of the present disclosure. In this regard, each block in a flowchart or block diagram may represent a module, program segment, or portion of code that contains one or more executable instructions for implementing a specified logical function. It should also be noted that in some alternative implementations, the functions noted in the blocks may also occur in an order different from that noted in the drawings. For example, two successively represented blocks may actually be executed substantially in parallel, and they may sometimes be executed in the reverse order, depending on the functionality involved. It is also noted that each block of the block diagrams and/or flowcharts, and combinations of blocks in the block diagrams and/or flowcharts, may be implemented with a dedicated hardware-based system that performs the specified functions or operations, or may be implemented with a combination of dedicated hardware and computer instructions.

The elements described in the embodiments of the present disclosure may be implemented in software or in hardware. The described unit may also be provided in a processor, which may be described, for example, as a processor comprising a text obtaining unit, a structure obtaining unit, and an input unit. Here, the names of these units do not constitute a limitation on the unit itself in some cases. For example, the text obtaining unit may also be described as “a unit that obtains text information of a cell in the table”.

As another aspect, the present disclosure also provides a computer-readable medium that may be included in the apparatus described in the above-described embodiments; It may also be present alone and not fitted into the device. The computer readable medium carries one or more programs which, when executed by the apparatus, cause the apparatus to obtain text information of a cell in the table, obtain structure information of a cell in the table; and input a query word, the text information, and the structure information of the table into a table information extraction model to obtain an answer output from the table information extraction model, wherein the output answer corresponds to the query word in the table.

The above description provides embodiments of the present disclosure and is illustrative of the principles of the techniques employed. It should be understood by those skilled in the art that the scope of the inventive subject matter in the present disclosure is not limited to the technical solutions formed by specific combinations of the above technical features, but also covers other technical solutions formed by any combination of the above technical features or their equivalents without departing from the inventive concept. For example, the above features and the technical features disclosed in the present disclosure (but not limited to) have been replaced with each other.

What is claimed is:

1. A method for processing a table, comprising:
obtaining text information of cells in the table;
obtaining structure information of the cells in the table; and
inputting a query word, the text information, and the structure information of the table into a table information extraction model to obtain an answer output from the table information extraction model, wherein the output answer corresponds to the query word in the table.

2. The method according to claim 1, wherein the text information comprises the text information of the cells and text information of cells on the left and right of the cells in the table; and
wherein the obtaining the text information of the cells in the table comprises:
splicing text contents of the cells in the table according to a preset splicing order to obtain a text sequence, wherein the splicing order comprises an order from left to right; and
determining the text information according to the text sequence.

3. The method according to claim 2, wherein splicing text contents of the cells in the table according to a preset splicing order to obtain a text sequence comprises:
using a position of the query word as a beginning position, and splicing the text contents of the cells in the table according to the preset splicing sequence from a subsequent position to obtain the text sequence.

4. The method according to claim 1, wherein the structure information is a vector; and
wherein the obtaining the structure information of the cells in the table comprises:
summing a row position, a column position a merging state and a cell token ID of each of the cells in the table to obtain summing information; and
determining the structure information based on the summing information.

5. The method according to claim 1, wherein the table information extraction model is obtained by:
obtaining text information and structure information of cells in a target table, and inputting the text information, the structure information and a query word of labeling information to a to-be-trained table information extraction model to obtain an output answer, wherein a truth value corresponding to the output answer in the labeling information is text content of a cell corresponding to a header of the target table;
training the to-be-trained table information extraction model by using the output answer and the truth value corresponding to the output answer to obtain a pre-trained table information extraction model; and
training the pre-trained table information extraction model by using training samples to obtain the trained table information extraction model.

6. An apparatus for processing a table, comprising:
at least one processor; and
a memory storing instructions, wherein the instructions when executed by the at least one processor, cause the at least one processor to perform operations, the operations comprising:
obtaining text information of cells in the table;
obtaining structure information of the cells in the table; and
inputting a query word, the text information, and the structure information of the table into a table information extraction model to obtain an answer output from the table information extraction model, wherein the output answer corresponds to the query word in the table.

7. The apparatus according to claim 6, wherein the text information comprises the text information of the cells and text information of cells on the left and right of the cells in the table; and
wherein the obtaining the text information of the cells in the table comprises:
splicing text contents of the cells in the table according to a preset splicing order to obtain a text sequence, wherein the splicing order comprises an order from left to right; and
determining the text information according to the text sequence.

8. The apparatus according to claim 7, wherein splicing text contents of the cells in the table according to a preset splicing order to obtain a text sequence comprises:
using a position of the query word as a beginning position, and splicing the text contents of the cells in the table according to the preset splicing sequence from a subsequent position to obtain the text sequence.

9. The apparatus according to claim 6, wherein the structure information is a vector; and
wherein the obtaining the structure information of the cells in the table comprises:
summing a row position, a column position a merging state and a cell token ID of each of the cells in the table to obtain summing information; and
determining the structure information based on the summing information.

10. The apparatus according to claim 6, wherein the table information extraction model is obtained by:
obtaining text information and structure information of cells in a target table, and inputting the text information, the structure information and a query word of labeling information to a to-be-trained table information extraction model to obtain an output answer, wherein a truth value corresponding to the output answer in the labeling information is text content of a cell corresponding to a header of the target table;
training the to-be-trained table information extraction model by using the output answer and the truth value corresponding to the output answer to obtain a pre-trained table information extraction model; and
training the pre-trained table information extraction model by using training samples to obtain the trained table information extraction model.

11. A non-transitory computer readable storage medium, storing computer instructions, wherein the computer instructions when executed by a computer cause the computer to perform operations comprising:
obtaining text information of cells in the table;
obtaining structure information of the cells in the table; and
inputting a query word, the text information, and the structure information of the table into a table information extraction model to obtain an answer output from the table information extraction model, wherein the output answer corresponds to the query word in the table.

12. The non-transitory computer readable storage medium according to claim 11, wherein the text information comprises the text information of the cells and text information of cells on the left and right of the cells in the table; and
wherein the obtaining the text information of the cells in the table comprises:
splicing text contents of the cells in the table according to a preset splicing order to obtain a text sequence, wherein the splicing order comprises an order from left to right; and
determining the text information according to the text sequence.

13. The non-transitory computer readable storage medium according to claim 12, wherein splicing text contents of the cells in the table according to a preset splicing order to obtain a text sequence comprises:
using a position of the query word as a beginning position, and splicing the text contents of the cells in the table according to the preset splicing sequence from a subsequent position to obtain the text sequence.

14. The non-transitory computer readable storage medium according to claim 11, wherein the structure information is a vector; and
wherein the obtaining the structure information of the cells in the table comprises:
summing a row position, a column position a merging state and a cell token ID of each of the cells in the table to obtain summing information; and
determining the structure information based on the summing information.

15. The non-transitory computer readable storage medium according to claim 11, wherein the table information extraction model is obtained by:
obtaining text information and structure information of cells in a target table, and inputting the text information, the structure information and a query word of labeling information to a to-be-trained table information extraction model to obtain an output answer, wherein a truth value corresponding to the output answer in the labeling information is text content of a cell corresponding to a header of the target table;
training the to-be-trained table information extraction model by using the output answer and the truth value corresponding to the output answer to obtain a pre-trained table information extraction model; and
training the pre-trained table information extraction model by using training samples to obtain the trained table information extraction model.
